(19) United States
(12) Patent Application Publication
(10) Pub. No.: US 2023/0169439 A1
(43) Pub. Date: Jun. 1, 2023

(54) AUTOMATED MANAGEMENT OF COMPLIANCE TRAINING

(71) Applicant: KnowBe4, Inc., Clearwater, FL (US)

(72) Inventors: Alex Callihan, Tampa, FL (US); Constantin Spatoulas, Tampa, FL (US); Mark Patton, Clearwater, FL (US); Matthew Duren, Tampa, FL (US)

(73) Assignee: KnowBe4, Inc., Clearwater, FL (US)

(21) Appl. No.: 17/988,980

(22) Filed: Nov. 17, 2022

Related U.S. Application Data
(60) Provisional application No. 63/284,154, filed on Nov. 30, 2021.

(51) Int. Cl. G06Q 10/06

(52) U.S. Cl. CPC G06Q 10/06398; G06Q 10/063114

(57) ABSTRACT

Methods and systems are provided for automated management of compliance training. One or more events triggered from one or more platforms that a user uses to carry out a job function is received via one or more adapters. In response to and based at least on the one or more events, a change of status of the user in the one or more platforms may be identified. Whether or not the change of status is to be allowed may be determined in each of the one or more platforms before the user completes a training. Responsive to the determination, the change of status of the user in the one or more platforms may be controlled.

### RELATED APPLICATIONS

This patent application claims the benefit of and priority to U.S. Provisional Patent Application No. 63/284,154 titled “AUTOMATED MANAGEMENT OF COMPLIANCE TRAINING,” and filed Nov. 30, 2021, the contents of all of which are hereby incorporated herein by reference in its entirety for all purposes

The present disclosure generally relates to compliance training. This disclosure generally relates to methods and systems for automated management of compliance training.

### BACKGROUND OF THE DISCLOSURE

Every employee who joins and works for an organization may have to comply with rules and regulations of the organization. To ensure the employee understands the rules and regulations, compliance training may be provided. Compliance training may be required by regulation or due to policies of an organization. One example of compliance training is occupational safety and health administration (OSHA) training that ensures safe and healthful working conditions for workers. The OSHA training is mandated by the Occupational Safety and Health Act of 1970 that requires employers to provide training to workers who face hazards on the job. In the course of a user's job, role or function, the user may interact with many systems that provide a service to the user. These systems may be referred to as platforms and are commonly implemented by software. Examples of platforms include Slack, GitHub, Jira, and QuickBooks.

An event is any change of status in a platform that is associated with a user. An event may be triggered in many different circumstances. For example, a user may start a job with an organization, triggering an event which is the addition of the user to a platform. In another example, an event may be triggered by a manager changing a user's permissions on a platform, or by the user joining a new project on a platform. In another example, an event may be triggered by a user having a change in their job role. In another example, an event may be triggered by a user being given access to platforms not previously accessible to the user (or access to platforms at a lesser/greater permission level). An event may be related to regulation or policy. For example, a policy may detail required compliance training for a user starting a job with the organization.

The workflow for providing compliance training to users is often manual and untargeted. When an event of a user requires compliance training, a manager or a system administrator may manually locate the appropriate compliance training materials, assign the compliance training to the user and/or provide the compliance training to the user. The compliance training assigned may include compliance training that is mandatory for the user at that time due to the event, and/or compliance training the user may require in future. The manager may have to monitor the user's progress until the user completes the compliance training. Upon user completion of the compliance training, the manager may have to record the completion for future auditing purposes.

The manual process described above has many shortcomings. It often occurs that the number of users, events, regulations, policies, or legislation exceed a system administrator's ability to monitor and manage compliance requirements. Management of compliance training is further complicated by the use of several platforms in day-to-day operations, each of which may support different events and require different compliance training. Also, employees in different departments may need to be treated differently. For example, HR employees may be regulated by different policies and require different compliance training than software development employees, even for the same event in the same platform. Because of such complexity of assigning correct compliance training, and repercussions of failing to assign compliance training that is needed, system administrators may opt to assign as much compliance training as they can to ensure a user has taken all required compliance training.

This tendency may result in a large amount of compliance training being assigned to a user when they start a job. The compliance training may not be related to what the user needs to know to complete their job. Additionally, the compliance training may not be relevant to the user's job functions until much later on. For example, a user may receive compliance training for going out for field work. But if the user does not go out for the field work, and stays in the office, field work-related compliance training may not be required. If at a later date, the employee goes out into the field, the user may not have retained the information from the compliance training on field work that they received at the beginning of their job well enough to apply the compliance training properly.

The amount of compliance training assigned at once, and the fact that assigned compliance training may not be relevant to the user at the time it is assigned, is likely to result in user disengagement from the compliance training. Additionally, time used to train users on compliance topics not currently relevant to their jobs is not time efficiently used. This can be frustrating and stressful for the user and may result in poor user retention of the compliance training material, which presents a risk for the organization.

### BRIEF SUMMARY OF THE DISCLOSURE

The present disclosure generally relates to management of compliance training. This disclosure generally relates to methods and systems for automated management of compliance training.

Methods and systems are provided for automated management of compliance training. In an example embodiment, a method includes receiving via one or more adapters one or more events triggered from one or more platforms that a user uses to carry out a job function, identifying responsive to and based at least on the one or more events, a change of status of the user in the one or more platforms, determining whether or not the change of status is to be allowed in each of the one or more platforms before the user completes a training and controlling responsive to the determination, the change of status of the user in the one or more platforms.

In some embodiments, the method further includes applying one or more rules to the one or more events to determine the training that is to be completed by the user before the change of the status is implemented in the one or more platforms.

In some embodiments, the method further includes determining a level of harm if the user is allowed the change in status in the one or more platforms before the user completes the training.

In some embodiments, the method further includes determining the change of status is to be allowed while the user completes the training.

In some embodiments, the method further includes determining the change of status of the user is to be withheld while the user completes the training.

In some embodiments, the method further includes identifying that the user is designated as a candidate for one or more types of the one or more events and assigning the user training to complete to implement the change in status in the one or more platforms.

In some embodiments, the method further includes causing the change in status in the one or more platforms responsive to the user completing the training.

In some embodiments, the method further includes causing the change in status in the one or more platforms and tracking progress or completion of the training of the user.

In some embodiments, the method further includes disabling the change in status in the one or more platforms responsive to the user not completing the training within a set period.

In some embodiments, the method further includes controlling the change of status in the one or more platforms by accessing the one or more platforms via one or more application programming interfaces (APIs).

Other aspects and advantages of the disclosure will become apparent from the following detailed description, taken in conjunction with the accompanying drawings, which illustrate by way of example the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIG. 1B is a block diagram depicting a could computing environment comprising client device in communication with cloud service providers;

FIGS. 1C and 1D are block diagrams depicting embodiments of computing devices useful in connection with the methods and systems described herein;

FIG. 2 depicts an implementation of some of the server architecture of an implementation of a system capable of automated management of compliance training, according to some embodiments;

FIG. 3 depicts an example of event record population by an adapter, according to some embodiments;

FIG. 4 depicts an example of the automated compliance training (ACT) system permission harm flowchart, according to some embodiments;

FIG. 5 depicts an example ACT system event flow that uses a push mechanism, according to some embodiments;

FIG. 6 depicts an example ACT system event flow that uses a pull mechanism, according to some embodiments; and

FIG. 7 depicts an example flowchart for management of compliance training, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods that are useful for automated management of compliance training.

### A. Computing and Network Environment

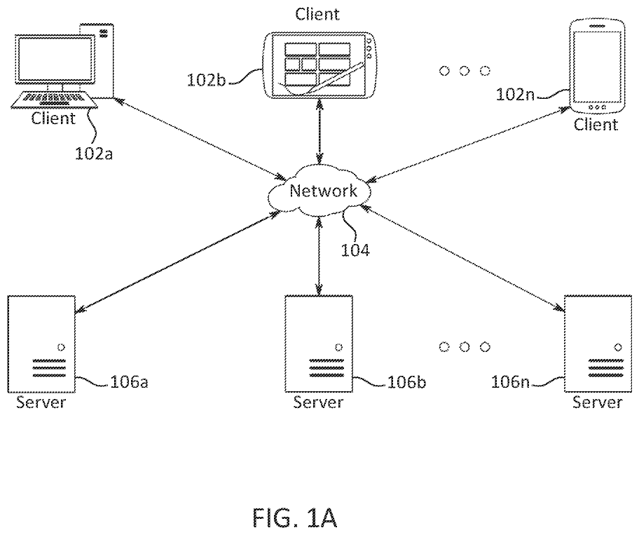

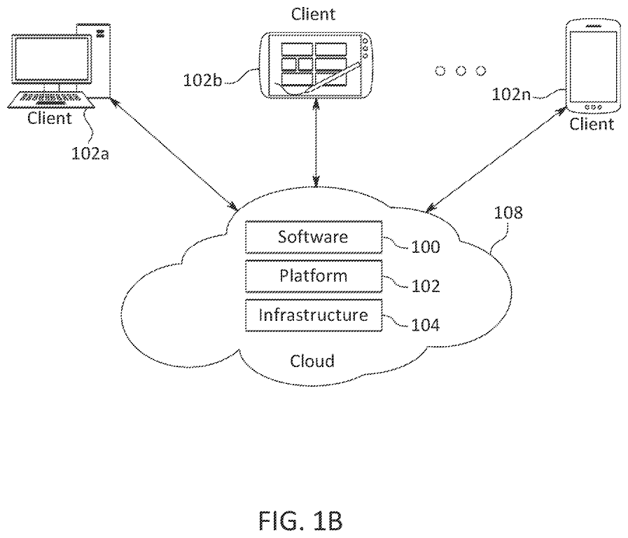

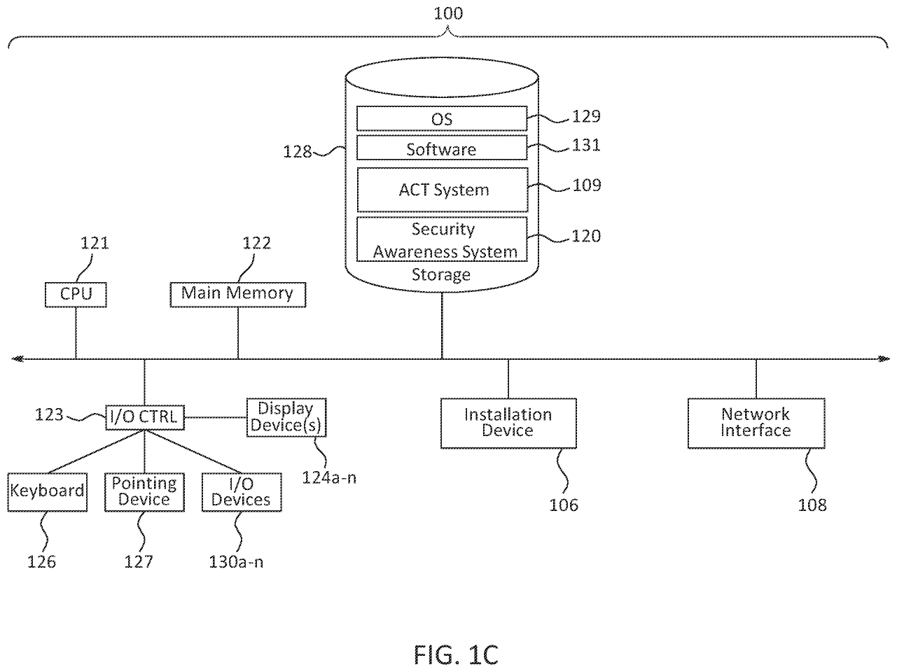

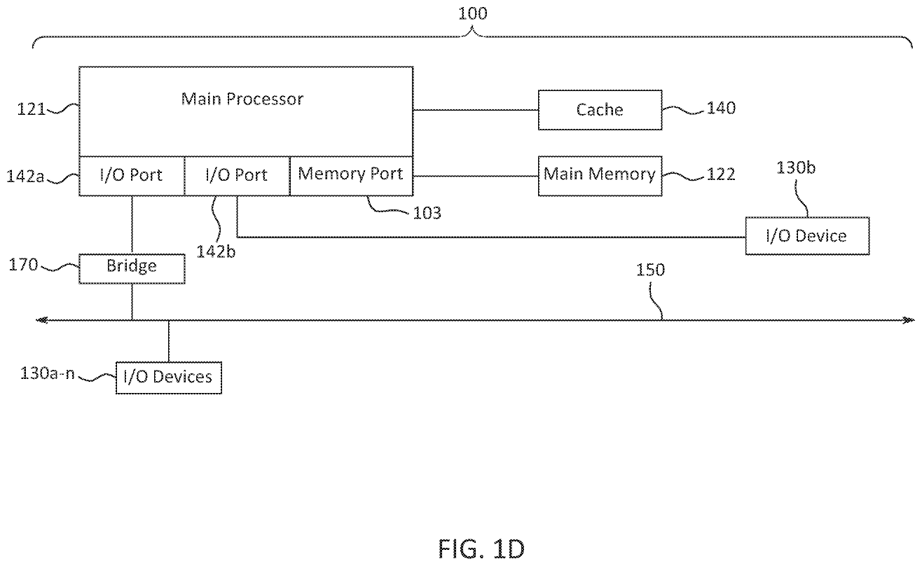

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP Internet protocol suite may include application layer, transport layer, Internet layer (including, e.g., IPv4 and IPv6), or the link layer. The network 104 may be a type of broadcast network, a telecommunications network, a data communication network, or a computer network.

In some embodiments, the system may include multiple, logically grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous—one or more of the servers 106 or machines 106 can operate according to one type of operating system platform (e.g., Windows, manufactured by Microsoft Corp. of Redmond, Wash.), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, Calif.; the Xen hypervisor, an open source product whose development is overseen by Citrix Systems, Inc. of Fort Lauderdale, Fla.; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, Calif.

Management of the machine farm may be de-centralized. For example, one or more servers 106 may comprise components, subsystems and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back-end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers or virtualization, as well as additional resources, e.g., the operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g. Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, Calif.). Clients 102 may also access SaaS resources through smartphone or tablet applications, including e.g., Salesforce Sales Cloud, or Google Drive App. Clients 102 may also access SaaS resources through the client operating system, including e.g. Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client 102 or a server 106. As shown in FIG. 1C and FIG. 1D, each computing device 100 includes a central processing unit (CPU) 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an Operating System OS) 129, software 131, a software of an Automated Compliance Training (ACT) system (109), and a software of a security awareness system 120. As shown in FIG. 1D, each computing device 100 may also include additional optional elements, e.g., a memory port 103, a bridge 170, one or more Input/Output (I/O) devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g. those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include on or more memory chips capable of storing data and allowing any storage location to be directly accessed by the central processing unit 121. Main memory unit 122 may be volatile and faster than storage 128 memory. Main memory units 122 may be Dynamic Random-Access Memory (DRAM) or any variants, including Static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the central processing unit 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts and embodiment in which the central processing unit 121 communicates directly with cache memory 140 via a secondary bus, sometimes referred to as a backside bus. In other embodiments, the central processing unit 121 communicates with cache memory 140 using the system bus 150. Cache memory 140 typically has a faster response time than main memory 122 and is typically provided by SRAM, BSRAM, or EDRAM. In the embodiment shown in FIG. 1D, the central processing unit 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the central processing unit 121 may use an Advanced Graphic Port (AGP) to communicate with the display 124 or the I/O controller 123 for the display 124. FIG. 1D depicts and embodiment of a computer 100 in which the central processing unit 121 communicates directly with I/O device 130b or other central processing units 121′ via HYPERTRANSPORT, RAPIDIO, or INFINIBAND communications technology. FIG. 1D also depicts an embodiment in which local busses and direct communication are mixed: the central processing unit 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices 130a-130n may be controlled by an I/O controller 123 as shown in FIG. 1C. The I/O controller may control one or more I/O devices, such as, e.g., a keyboard 126 and pointing device 127, e.g., a mouse or optical pen. Furthermore, an I/O device may also provide storage and/or an installation device 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g. a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software of the ACT system 109 or the software of the security awareness system 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116 and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMAX and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Wash.; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the iPhone family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Automated Management of Compliance Training

The following describes systems and methods for automated management of compliance training. The disclosure describes systems and methods that automatically select, oversee, and record compliance training for users based on events such as changes to permissions for the users or changes to a users' role in a platform. The compliance training may be a mandated instruction to ensure that a user is informed regarding any regulation, legislation, or polices applicable to their status within a platform, and completion of which may bring a user or organization into compliance. For example, a change in status of a user to a lifeguard may necessitate compliance training that includes a Cardiopulmonary Resuscitation (CPR) certification. The CPR certification may align with a policy that requires lifeguards know how to resuscitate others. The systems and methods of the disclosure evaluate changes automatically, and determine one or more rules to apply an appropriate compliance training as well as other related actions. The result is that compliance training is delivered to a user as required to comply with regulations but without inundating them with unnecessary or out-of-context training that may lead to the user's disengagement.

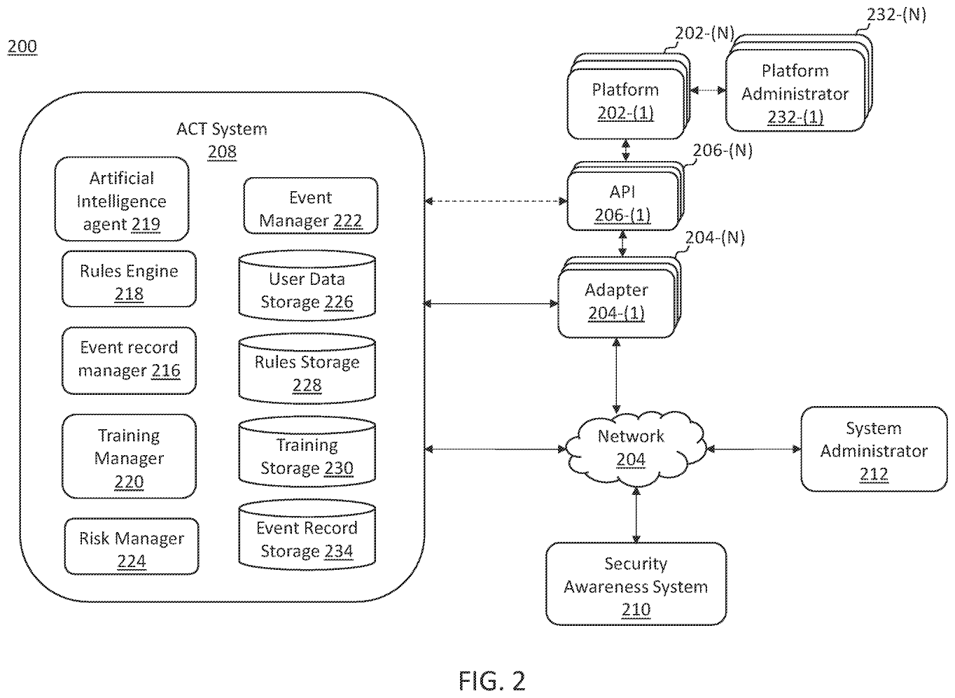

Referring to FIG. 2, in a general overview, FIG. 2 depicts some of a server architecture of an implementation of system 200 for automated management of compliance training. FIG. 2 may include platforms 202-(1-N), adapters 204-(1-N), application program interfaces (API) 206-(1-N), Automated Compliance Training (ACT) system 208, security awareness system 210, system administrator 212 and network 214 enabling communication between the system components for information exchange. Network 214 may be an example or instance of network 104, details of which are provided with reference to FIG. 1A and its accompanying description.

Platforms 202-(1-N) may be tools or environments used by one or more users in an organization to perform job functions. A user may utilize one or more platforms 202-(1-N). Example platforms 202-(1-N) include, but are not limited to, Jira, GitHub, Box, Confluence, Slack, Salesforce, Lucidchart, Office 365 and Google Workspace. In some examples, a user may have different statuses in one or more platforms. In an example, a status may be a role or position assigned in a platforms 202. A role or position may define a level of access or privileges provided in a platforms 202. For example, a ‘viewer only’ role for a user in Lucidchart may only provide viewing access to a Lucidchart project without any ability for the user to edit or share the project.

Organizations may use several platforms 202-(1-N) in day-to-day operations. One or more platform administrators 232-(1-N) may administer one or more platforms 202-(1-N). In some examples, administration may include overseeing and managing corresponding platforms 202-(1-N). Platform administrator 232 may be an individual or team overseeing and managing one or more platforms within the organization. Platform administrator 232 may initiate events, create events, halt events, assign user status, change user status and remove user status within a one or more platforms 202-(1-N). One example of platform administrator 232 includes an HR administrator who may manage platforms such as Dayforce and QuickBooks platforms. Another example of platform administrator 232 may include a manager of a development team managing a GitHub platform. Because the HR platform administrator may not be aware of status or events that need to occur in the GitHub platform for a user to complete their job, the HR administrator does not manage the GitHub platform.

Adapters 204-(1-N) may be components of ACT system 208 or may interact with ACT system 208 and may receive one or more events triggered from one or more platforms 202-(1-N) that a user uses to carry out a job function. Adapters 204-(1-N) may retrieve information from one or more platforms 202-(1-N) associated with events occurring on platforms 202-(1-N) and may populate event records for processing. In some examples, adapters 204-(1-N) may periodically retrieve information from one or more platforms 202-(1-N) associated with one or more events. In some examples, adapters 204-(1-N) may be prompted by event record manager 216 to retrieve information (also referred to as a pull mechanism) from one or more platforms 202-(1-N) associated with one or more events. In some examples, adapters 204-(1-N) may retrieve information from one or more platforms 202-(1-N) associated with one or more events responsive to notification from corresponding platforms 202-(1-N) or detection of events from corresponding platforms 202-(1-N) (also referred to as a push mechanism). Adapters 204-(1-N) may retrieve information from one or more platforms 202-(1-N) through corresponding APIs 206-(1-N). APIs 206-(1-N) are programs that enable applications to communicate with one another. APIs 206-(1-N) are not explained in detail as they are known in the art. Adapters 204-(1-N) may format information retrieved from platforms 202-(1-N) in a manner that is common for all platforms 202-(1-N) and which can be processed by ACT system 208. In some examples, there may be one adapter 204-(1-N) configured for each platform 202-(1-N). In some examples, there may be a common adapter 204-(1-N) to multiple platforms 202-(1-N). In FIG. 2, as an example illustration, the number of adapters 204-(1-N) are shown to be equal to the number of platforms 202-(1-N), although this is not required.

ACT system 208 is configured to automate the management of compliance training. ACT system 208 facilitates compliance training via event monitoring, computer-based training, progress tracking, and permissions and access management. ACT system 208, inter alia, may include event record manager 216, rules engine 218, training manager 220, event manager 222, risk manager 224, Artificial Intelligence (AI) agent 219, user data storage 226, rules storage 228, training storage 230, and event record storage 234.

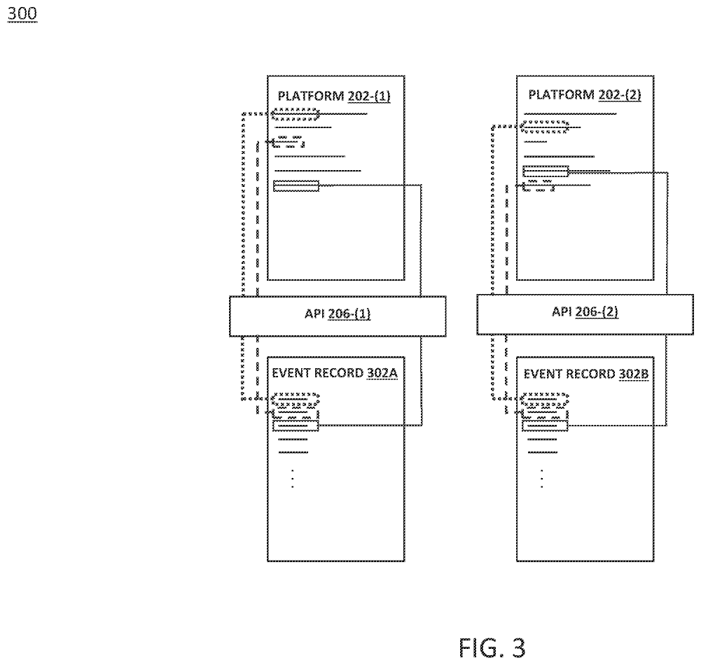

Event record manager 216 may be configured to process one or more event records. In one example, adapters 204-(1-N) may detect one or more events in one or more platforms 202-(1-N). In some examples, event record manager 216 may receive notification of one or more events from platforms 202-(1-N) or from other sources. Responsive to detecting events or receiving notifications, in one example, event record manager 216 may prompt one or more adapters 204-(1-N) to identify event information, create event records, and send event records. In some examples, event record manager 216 may receive event records without prompting one or more adapters 204-(1-N). In examples, an event record includes information related to an event from one or more platforms 202-(1-N). For example, an event record may include event information related to a user or a change in status of the user. Some examples of event information related to a user or the change in user status include the identity of the user, the platform identity, the organization's identity, the time of the event, the user permissions in the platform (in examples, this includes user permissions before, user permissions during and user permissions after the event), the user's job title, and any other relevant information about the user, the event or the change in the user's status. The event record may comprise information obtained from various platforms 202-(1-N) in a common format, as illustrated in FIG. 3.

Event record manager 216 may process information in the event record to extract data, such as platform identity, organization's identity, user's identity, change in status of the user in platform 202-(1-N). In an example, event record manager 216 may be configured to process event records periodically, such as hourly or daily. In some examples, event record manager 216 may process event records on demand when requested to do so by system administrator 212. In some examples, event record manager 216 may be configured to prompt the creation of event records by adapter 204-(1-N) automatically or periodically. In some examples, event record manager 216 may be configured to process event records associated with a specific platform 202 every time a new event occurs on the platform 202 or every time a specific event occurs on the platform 202. An event may trigger or notify one or more adapters 204-(1-N) or event record manager 216 to process event records, for example, an event record comprising a user status change for platform 202 from having viewer permissions to having editor permissions. In some examples, event record manager 216 may cache and withhold the change in status of the user until the user has completed compliance training before providing the change in status of the user to platform 202, enabling platform 202 to proceed with the status change of the user. Event record manager 216 may record and indicate to the user that their change in status is being withheld until the assigned compliance training has been completed. In examples, event record manager 216 may cause platform 202 to record and indicate to the user that their change in status is being withheld until the assigned compliance training has been completed. Upon the completion of the assigned compliance training, event record manager 216 may apply the user status change within the platform. In examples, upon completion of the assigned compliance training, event record manager 216 may cause platform 202 to apply the user status change or may send an indication to platform 202 that the user is eligible for the user status change. In some examples, event record manager 216 may indicate a status of the user (e.g., a user's status as an “editor candidate”) within ACT system 208 or event record manager may send an indication of a candidate status of the user to platforms 202-(1-N)). Event record manager 216 may store event records in event record storage 234. Event record storage 234 may be a database or repository that is configured to store event records for one or more users.

Rules engine 218 may apply one or more rules to determine appropriate compliance training that is to be completed by the user before, during, or after a change of a status is implemented in one or more platforms 202-(1-N), or eligibility of a change of status is indicated to the one or more platforms 202-(1-N) by ACT system 208. In an example, rules engine 218 may apply rules based on information contained in event records. In one or more embodiments, system administrator 212 or an Artificial Intelligence (AI) agent 219 may determine and provide the one or more rules based on data associated with status and/or from policies or regulations. In some examples, the role or functions of system administrator 212 may be automated or realized by using an AI agent 219. In examples, AI agent 219 may be embedded into rules engine 218 or may perform functions in coordination with rules engine 218. A rule may combine any items of data or condition of items of data (e.g., stored, missing, updated, etc.) stored in an event record or in other data stores. Rules engine 218 may apply one or more rules based on data in an event record that influence how ACT system 208 provides appropriate compliance training to one or more users, and/or whether any other action occurs for the user, such as being added to communication channels. In some examples, rules engine 218 may also have the capability to prioritize rules and process rules hierarchically. For example, a rule may check the recurrence of compliance training assigned to a user in user data storage 226 to ensure the user is not being retrained with the same compliance training more than once time period, for example every N days (where N may be set by policy, regulations or by system administrator 212) regardless of a rule being triggered. In an example, a rule from rules engine 218 may be expressed as “assigned >180 days” implying the user will only be assigned the training again if it has been more than 180 days since the user was last assigned the training. In some examples, rules engine 218 may determine a rule or multiple rules in combination to determine appropriate compliance training for a user based on one or more events.

Training manager 220 may assign user training, track a user's progress in compliance training, provide status of training progress and completion, and create an audit trail of training completion. In some examples, training manager 220 may assign compliance training to a user in response to the matching of conditions of a rule or of multiple rules in combination. Training manager 220 may prompt one or more users to complete compliance training, or training monitor 220 may monitor the progress of compliance training, and identify compliance training completion by one or more users. In some examples, training manager 220 may incorporate Machine Learning (ML) and/or AI to assist with monitoring users as they complete compliance training by monitoring trends in user responsiveness towards prompts to complete compliance training. For example, training manager 220 may identify that a user is more likely to complete assigned compliance training on time if the user is prompted first thing in the morning. Training manager 220 may obtain compliance trainings from training storage 230.

Event manager 222 may be a component of ACT system 208 configured to control one or more event commands. Event manager 222 may be configured to intercept or revoke one or more event commands that platform administrators 232-(1-N) send to one or more platforms 202-(1-N) or any event commands that are sent to a platform from any other component of system 200, for example where event commands may alter status of the user. As a result, event manager 222 may prevent the one or more event commands from being executed by one or more corresponding platforms 202-(1-N). In some examples, event manager 222 may have credentials, access through API 206-(1-N), or direct access to platforms 202-(1-N) to intercept one or more event commands.

Risk manager 224 may determine a risk that an organization assumes by allowing the user to receive or acquire a new status before they complete assigned compliance training. In some examples, risk manager 224 may use ML and/or AI to determine, measure, or quantify the risk or the change in risk that the organization would have if the new status for the user were implemented before they complete assigned compliance training. In example, risk manager 224 may provide the organization risk as an organizational risk score. In examples, risk manager 224 may provide a change in organizational risk as a change or delta applicable to a previous organizational risk score. In some examples, risk manager 224 may determine a length of time that is appropriate for a user to complete compliance training. In some examples, system administrator 212 may perform a role of risk manager 224. In some examples, the role of risk manager 224 may be automated or realized by using an Artificial Intelligence (AI) program, for example by AI agent 219. In one or more embodiments, risk manager 224 may control implementation of a change in a user status for one or more platforms 202-(1-N) associated with one or more event by one of three of following methods: an intercept method, a revoke method, and a candidate method.

In examples of an intercept method, event manager 222 may intercept an event command that platform administrator 232 has sent to a platform 202 or an event command that is sent to a platform 202 from another organization user or system to alter a status of the user. Training manager 220 may deliver, recommend, or provide in a user training console a corresponding compliance training associated with the user status change to the user. Event record manager 216 may cache the user status change command for platform 202 to be withheld until the compliance training has been completed by the user. Event manager 222 may record and indicate to the user that their change in status is being withheld until the corresponding compliance training has been completed. Upon the completion of the corresponding compliance training, event manager 222 may apply the user status change within the platform 202, cause the user status change to be applied within the platform 202, or indicate to platform 202 that the user status change may be applied. In examples, event manager 222 may cause the user status change command to be removed from the cache and be delivered to platform 202.

In an example of a revoke method, event record manager 216, event manager 222 or adapter 204-(1-N) may detect, or is notified of an event on platform 202. Upon detecting or receiving notification of the event, event record manager 216 may communicate a command to the platform 202 to revoke the event (thereby reverting the user to their status prior to the event), and training manager 220 assigns the user corresponding compliance training associated with the event. In examples, event record manager 216 may indicate or communicate a command to the platform 202 prevent the event from occurring until the user has completed the corresponding compliance training. Upon completion of the corresponding compliance training, event record manager 216 may indicate or communicate a command to the platform 202 to trigger the event. In examples, if the user does not complete the corresponding compliance training within a given time period, event record manager 216 or event manager 222 may indicate or communicate a command to the platform 202 to revoke the event, inhibiting the user change in status in the platform 202 (that is, to revert the user to their status as it was prior to the event).

In an example of a candidate method, event record manager 216, event manager 222 or adapter 204-(1-N) may detect or may be notified of an event associated with a user for platform 202. In examples based on the detection or notification of the event, system administrator 212 may designate the user as a “candidate” for a changed user status for platform 202 associated with the event. The “candidate” designation for the user may be an indication to ACT system 208 that system administrator 212 or platform administrator 232 of platform 202 may have selected or indicated that the user is entitled to utilize the changed user status associated with the event for platform 202 by applying a designation in user data storage 226 as a “candidate” for that changed user status for the user for the platform 202. Training manager 220 may assign or provide corresponding compliance training associated with the change in user status for platform 202. Upon completion of the corresponding compliance training, the “candidate” designation on the user for that changed user status is removed, and the user is given the status in platform 202. If the user does not complete the corresponding compliance training within a given time period, event record manager 216 or event manager 222 may revoke the event (for example, causing the user to retain their previous user status prior to the event), and the “candidate” designation for the changed user status may be removed.

To determine which of the intercept method, the revoke method, and the candidate method are to be used for a particular user status change or an event, risk manager 224 may determine whether there is any harm (for example, a possible increase in the organizational risk score) in granting the user the new user status for a platform 202 associated with the event before the completion of the assigned corresponding compliance training, or if the user's new user status should only be applied for platform 202 after the completion of the assigned corresponding compliance training. In examples, risk manager 224 may determine the length of time that is appropriate for a user to complete assigned corresponding compliance training based on the time of occurrence of the associated event. In an example of the candidate method, a user may be granted the new user status before completing assigned corresponding compliance training to fulfill necessary job functions while ensuring that the user will not have continuous, long term, or permanent access or changed user status without completing the assigned corresponding compliance training. Risk manager 224 may determine whether there is the potential of any harm (for example, a possible increase in the organizational risk score) in granting the user the new user status for platform 202 associated with an event before the completion of the assigned corresponding compliance training or the risk manager 224 may determine the length of time that is appropriate or acceptable for the user to complete the assigned corresponding compliance training, for example based on rules, laws, or organizational policies.

User data storage 226 is a storage unit that may store data regarding the history of a user's status, events associated with platforms 202-(1-N), compliance training history, and any other data related to a user. Rules storage 228 may store rules that define one or more actions or requirements, such as compliance training that the user has to undergo in response to a corresponding event associated with platform 202. Training storage 230 may store one or more compliance training modules or programs or any training content such as compliance training programs that are used for training the one or more users in response to one or more events associated with platforms 202-(1-N).

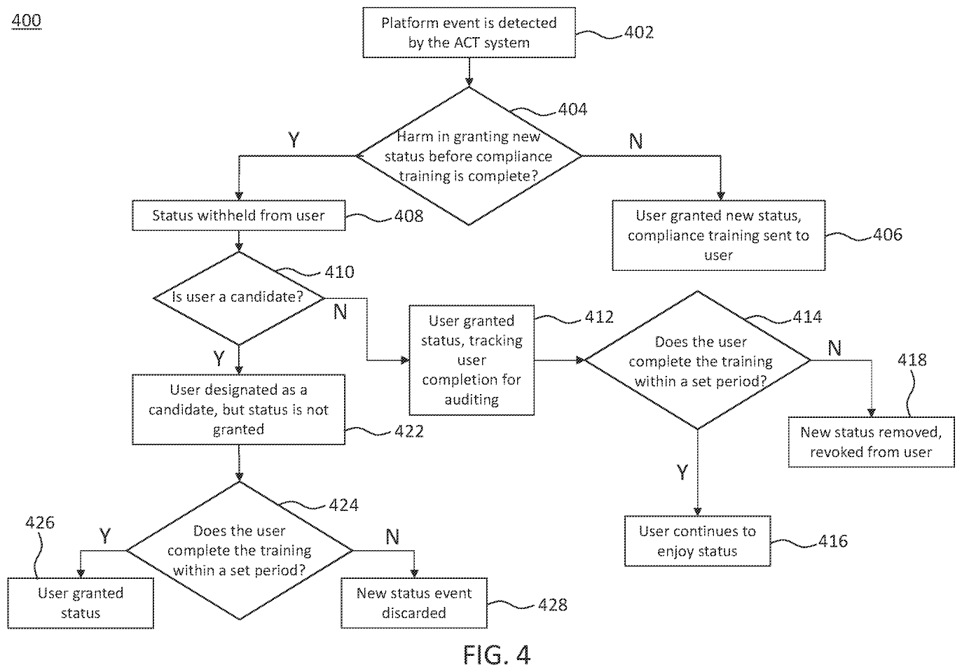

Referring back to FIG. 2, system administrator 212 may be an individual or team who oversees ACT system 208 or security awareness system 210 of an organization with responsibilities including configuration of ACT system 208 or security awareness system 210, personal information use and management, managing the identification or assignment of compliance training, simulated phishing campaigns and simulated attacks, and managing any other element within the ACT system 208 or security awareness system 210. In some examples, system administrator 212 may perform one or more functions of risk manager 224. For example, system administrator 212 may determine which method of methods of managing an event or change in user status of platform 202 should be used, for example determining a method or methods among one or more of the intercept method, the revoke method, and the candidate method, to determine whether there is the potential for any harm (for example, a possible increase in the organizational risk score) in granting the user the new user status associated of the event for platform 202 before the completion of the assigned corresponding compliance training, or if the user's new user status should only be applied after the completion of the assigned corresponding compliance training. In another example, system administrator 212 may determine a length of time that is appropriate for a user to complete assigned corresponding compliance training. System administrator 212 may identify one or more rules which may be used to determine for how long a user may benefit from the new user status before completing assigned corresponding compliance training. An example process for risk manager 224 that determines if there is potential harm (for example, a possible increase in the organizational risk score) in granting the new status to the user before the completion of the compliance training and whether a user needs to complete the compliance training within a certain timeframe is illustrated in FIG. 4.

Security awareness system 210 may be a platform that monitors, identifies, and manages cybersecurity attacks including phishing attacks faced by the organization or by the users within the organization. In an implementation, security awareness system 210 may manage cybersecurity awareness for the organization. In an example, a user of the organization may include an individual that can or does receive an electronic message. For example, the user may be an employee of the organization, a member of a group, an individual who acts in any capacity of security awareness system 210, such as a security authority, or anyone associated with the organization. The security authority may be a professional (or a team of professionals) managing organizational cybersecurity aspects. The security authority may oversee and manage security awareness system 210 to ensure cybersecurity goals of the organization are met. For example, the security authority may oversee Information Technology (IT) systems of the organization for managing simulated phishing campaigns, identification and classification of threats within reported emails, selection of simulated phishing communications (or simulated phishing messages), and any other element within security awareness system 210. Examples of the security authority include an IT department, a security team, a manager, or an Incident Response (IR) team. In some embodiments, security awareness system 210 may be owned or managed or otherwise associated with an organization or any entity authorized thereof. In an example, the organization may be an entity that is subscribed to or makes use of services provided by security awareness system 210. The organization may encompass all users within the organization, vendors to the organization, or partners of the organization.

According to one or more embodiments, security awareness system 210 may be implemented in a variety of computing systems, such as a mainframe computer, a server, a network server, a laptop computer, a desktop computer, a notebook, a workstation, and any other computing system. In an implementation, security awareness system 210 may be implemented in a server, such as server 106 shown in FIG. 1A. In some implementations, security awareness system 210 may be implemented by a device, such as computing device 100 shown in FIG. 1C and FIG. 1D. In some embodiments, security awareness system 210 may be implemented as a part of a cluster of servers. In some embodiments, security awareness system 210 may be implemented across a plurality of servers, thereby, tasks performed by security awareness system 210 may be performed by the plurality of servers. These tasks may be allocated among the cluster of servers by an application, a service, a daemon, a routine, or other executable logic for task allocation. The term “application” as used herein may refer to one or more applications, services, routines, or other executable logic or instructions. Security awareness system 210 may comprise a program, service, task, script, library, application or any type and form of executable instructions or code executable on one or more processors. Security awareness system 210 may be implemented by one or more modules, applications, programs, services, tasks, scripts, libraries, applications, or executable code.

ACT system 208 and security awareness system 210 may be implemented in a variety of computing systems, such as a mainframe computer, a server, a network server, a laptop computer, a desktop computer, a notebook, a workstation, and any other computing system. In an implementation, ACT system 208 and security awareness system 210 may be implemented in a server, such as server 106 shown in FIG. 1A. In some implementations, ACT system 208 and security awareness system 210 may be implemented by a device, such as computing device 100 shown in FIG. 1C and FIG. 1D. In some embodiments, ACT system 208 and security awareness system 210 may be implemented as a part of a cluster of servers. In some embodiments, ACT system 208 and security awareness system 210 may be implemented across a plurality of servers, thereby, tasks performed by security awareness system 210 may be performed by the plurality of servers. These tasks may be allocated among the cluster or plurality of servers by an application, a service, a daemon, a routine, or other executable logic for task allocation. The term “application” as used herein may refer to one or more applications, services, routines, or other executable logic or instructions. ACT system 208 and security awareness system 210 may comprise a program, service, task, script, library, application or any type and form of executable instructions or code executable on one or more processors. ACT system 208 and security awareness system 210 may be implemented by one or more modules, applications, programs, services, tasks, scripts, libraries, applications, or executable code.

In some embodiments, ACT system 208 and security awareness system 210 may be owned or managed or otherwise associated with an organization or any entity authorized thereof. In an implementation, ACT system 208 and security awareness system 210 may manage compliance requirements and cybersecurity awareness for the organization. In an example, the organization may be an entity that is subscribed to or makes use of services provided by ACT system 208 and/or security awareness system 210. The organization may encompass all users within the organization, vendors to the organization, or partners of the organization, or any other entities affiliated with the organization. Although FIG. 2 illustrates ACT system 208 and security awareness system 210 implemented as separate functions, it can be appreciated that ACT system 208 and security awareness system 210 can be implemented as one function.

FIG. 3 depicts an example of event record population through API 206-(1-N), according to some embodiments. FIG. 3 illustrates examples of platform 202-(1), platform 202-(2), API 206-(1), platform 202-(2), event record 302A, and event record 302B. Platform 202-(1) and platform 202-(2) illustrate different formats of holding information related to events associated with the respective platform. As described, responsive to a request from system administrator 212, detection and/or notification of one or more events or configuration associated with platforms 202-(1-N), adapters 204-(1-N) may obtain information (for example on being prompted by event record manager 216 or automatically) from platforms 202-(1-N). Regardless of differences in formats of information in various platforms 202-(1-N), adapters 204-(1-N) may collect the information and populate the information in an event record in a uniform format. FIG. 3 shows adapter 204-(1) and adapter 204-(2) obtaining information from platform 202-(1) and platform 202-(1), respectively. As shown as an example, adapter 204-(1) populates information of first type, information of second type, and information of third type into event record 302A through dotted line representation, dashed line representation, and line representation, respectively. Similarly, adapter 204-(2) populates information of first type, information of second type, information of third type being populated into event record 302B through dotted line representation, dashed line representation, and line representation, respectively. It can be seen in FIG. 3, the positions or locations of information of first type, information of second type, information of third type are different in the event records of platform 202-(1) and platform 202-(2). The resulting event record 302A and event record 302B illustrate the information of first type, information of second type and information of third type from platform 202-1 and platform 202-2 populated in a uniform format in event record 302A and event record 302B, respectively.

FIG. 4 depicts an example of an ACT system permission harm flowchart, according to some embodiments. The ACT system permission harm flowchart illustrates the steps taken in the determination of the potential harm in granting a new user status to a user for a platform 202 before corresponding compliance training is completed. The ACT system permission harm flowchart illustrates an example of the determination of which of the revoke method, the intercept method, and the candidate method is employed. In step 402, an event associated with platform 202 may be detected by ACT system 208. In an example, platform 202 may notify the ACT system 208 about the event. In examples, the event is associated with a change in a user status for platform 202. In step 404, ACT system 208 may determined whether there is potential harm in granting a new status to a user before a compliance training (for example, whether there the organizational risk score would increase). In an example, risk manager 224 may determine a level of potential harm or of potential risk score increase to the organization by granting a new status to a user before a compliance training and measuring security events. In examples, risk manager 224 may assess based on historic information from one or more users of one or more organizations (which may or may not include the organization or the user of the organization), for example where the historical information measures the actual increase in an organizations risk based on actions of users who experience a change in user status for a platform 202 without, prior to, or during corresponding compliance training, the potential harm or increase in risk that the organization may face. Responsive to determining that there is little or no potential harm in granting the new user status to the user before the corresponding compliance training, in step 406, the new user status may be granted to the user and a corresponding compliance training is sent to the user. In an example, training manager 220 may send the corresponding compliance training to the user.

Responsive to determining that there is potential harm in granting the new user status to the user before or during the corresponding compliance training, in step 408, the new user status may be withheld from the user. In some examples, risk manager 224 may determine a level of potential harm (in a qualitative or quantitative form: e.g., low, medium, high) if the user is allowed the change in user status in the one or more platforms 202-(1-N) before the user completes the training. In step 410, it may be determined whether the user is a candidate for the change in user status (for example, instead of being granted the change in user status). In an example, risk manager 224 or system administrator 212 may determine or identify the user as a candidate for the change in user status. In response to determining that the user is not a candidate for the change in user status, in step 412, the user may be granted the new user status while the user completes the corresponding compliance training, and the user completion of corresponding compliance training may be tracked by training manager 220 or ACT system 208, for example for auditing or reporting purposes.

In step 414, ACT system 209 may determine whether the user completes the compliance training within a set period. In examples, within a set period means within a period of time. In an example, training manager 220 may track and determine whether the user has completed the compliance training. In response to determining that the user has completed the compliance training within the set period, in step 416, the user may be allowed to continue to enjoy the new user status. In an example, event manager 222 may provide an indication to platform 202 that the user has met the compliance training requirements to obtain the new user status. In response to determining that the user has not completed the compliance training within the set period, in step 418, the new user status for the user may be removed and/or revoked. In an example, training manager 220 may track and determine whether the user has completed the training. In an example, in step 418 event manager 222 may remove and/or revoke the new user status. In an example, in step 418, event manager 222 may provide an indication to platform 202 that the user has not met the compliance training requirements, and/or that the new user status for the user should be revoked.

Referring back to step 410, ACT system 208 determines whether the user is a candidate. Responsive to determining that user is a candidate, in step 422, the user may be designated as the candidate, and the change in user status may not be granted. In an example, event record manager 216 or event manager 222 may prevent the change in user status, for example using methods previously described, such as intercepting and caching the event. In examples, event record manager 216 or event manager 222 may provide an indication to platform 202 that platform 202 not grant the change in user status to the user. In step 424, ACT system 208 may determine whether the user completes the compliance training within a set period. In an example, training manager 220 may track the completion of the compliance training. In response to determining that the user has completed the compliance training within the set period, in step 426, the new user status may be granted to the user. In an example, in step 426 event manager 222 may apply or add the new user status. In an example, in step 426, event manager 222 may provide an indication to platform 202 that the user has met the compliance training requirements, and/or that the new user status for the user should be applied.

Otherwise, in step 428, if the user does not complete the compliance training within the set period, the new user status for the user may be discarded. In an example, event record manager 216 may not grant or may discard the new user status of the user based on the user failing to complete the compliance training within the set period. In an example, in step 428 event manager 222 may discard the new user status. In an example, in step 428, event manager 222 may provide an indication to platform 202 that the user has not met the compliance training requirements in the set period, and/or that the new user status for the user should be discarded.

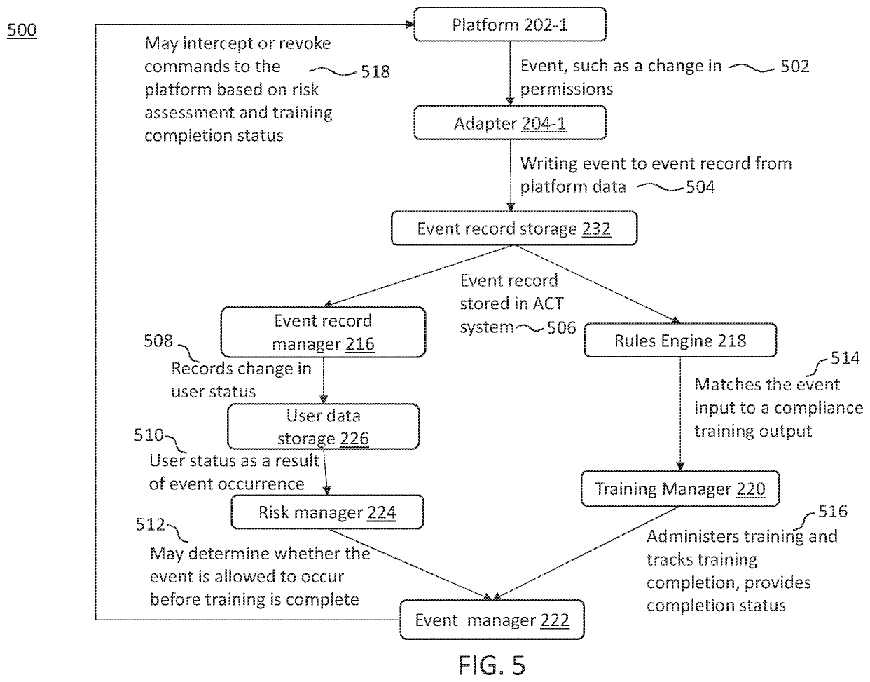

FIG. 5 depicts an example ACT system 208 event flow 500 that uses a push mechanism, according to some embodiments. In examples, ACT system 208 automatically manages compliance training for users in response to events or changes in user status for the user. ACT system 208 may enable platform administrators 232-(1-N) to work in collaboration with system administrator 212 to provide compliance training to a user. For sake of brevity, FIG. 5 is described with ACT system 208 and a single instance of components, that is, platform 202-1, adapter 204-1, etc.

In step 502, platform administrator 232 associated with platform 202-1 may initiate an event by sending an event command to platform 202-1. The event may be a change in a status of the user. In the push mechanism, platform 202 may notify adapter 204-1 of the event as the event occurs or after the event occurs. In step 504, adapter 204-1 in receipt of the notification, may obtain information related to the event, and may generate an event record by collecting and storing event information associated with the event. Adapter 204-1 may provide the event record to event record manager 216 and in step 506, may save the event record in event record storage 234 or user data storage 226.

In step 508, event record manager 216 may process the event record and record the change in user status. In step 510, event record manager 216 may save user status as a results of event occurrence in user data storage 226. In step 512, risk manager 224 may determine whether to grant a new user status of the event to the user before the completion of compliance training corresponding with the event, or if the user's new user status is applied after the completion of the corresponding compliance training. System administrator 212 or risk manager 224 may determine the length of time that is appropriate for a user to complete training corresponding with the event. Training manager 220 may assign, administer and track user progress with the corresponding compliance training. Training manager 220 may also create a record of the user's progress with the corresponding compliance training and may store the record in user data storage 226. Risk manager 224 or system administrator 212 may decide whether there is harm in granting a user a new user status in relation to an event before the completion of the corresponding compliance training, or if the new status should be applied after the completion of the compliance training.

In step 514, rules engine 218 may match one or more rules that matches the event to determine a corresponding compliance training. In step 516, training manager 220 administers corresponding compliance training, tracks user's compliance training progress and completion, and provides user compliance training completion status. In step 518, based on risk assessment performed by risk manager 224 and/or based on compliance training completion status determined by training manager 220, event manager 222 may intercept or revoke commands to platform 202-1, for example commands to apply the new user status for platform 202-1.

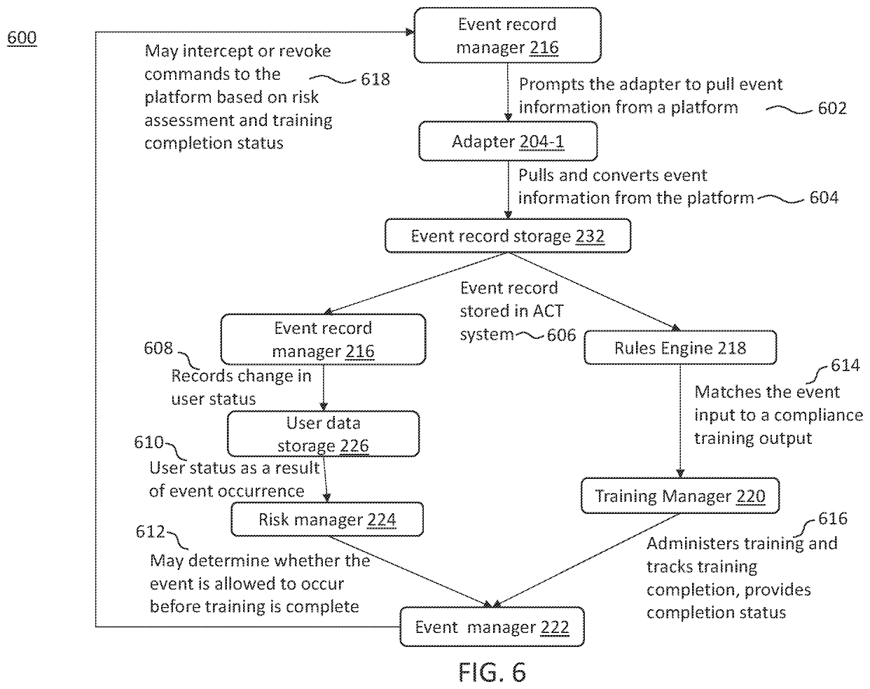

FIG. 6 depicts an example ACT system 208 event flow 600 that uses a pull mechanism, according to some embodiments. For sake of brevity, FIG. 6 is described with ACT system 208 and a single instance of components, that is platform 202-1, adapter 204-1, etc.

Platform administrator 232-1 may initiate an event by sending an event command to platform 202-1. In the pull mechanism, when an event occurs on platform 202-1, event record manager 216 may receive notifications on the event. In step 602, event record manager 216 may prompt adapter 204-1 to pull event information from platform 202-1 based on a pull configuration. A pull configuration may describe a frequency or periodicity with which adapter 204-1 pulls event information from platform 202-1. In an example, adapter 204-1 pulls event information from platform 202-1 that is new or different from the previous instance of event information pulled from platform 202-1. In examples, adapter 204-1 pulls event information that is recent within a certain time period, which may be equal to or greater than the time since the last instance of adapter 204.1 pulling event information from platform 202-1. An example of a pull confirmation of adapter 204-1 is being configured to periodically pull event information. In step 604, adapter 204-1 may generate an event record by collecting and storing information associated with the event. Adapter 204-1 may obtain information related to the event and generate an event record by additionally converting information associated with the event into a uniform format. In step 606, adapter 204-1 may store the event record in event record storage 234.

In step 608, event record manager 216 may process the event record and record the change in user status. In step 610, event record manager 216 may save user status in user data storage 226 as a result of event occurrence. In step 612, risk manager 224 may determine whether to grant a new user status of the event for platform 202-1 to the user before the completion of the corresponding compliance training, or if the user's new user status for platform 202-1 is applied after the completion of the compliance training. System administrator 212 or risk manager 224 may determine the length of time that is appropriate for a user to complete corresponding compliance training. Training manager 220 may assign, administer and track user progress with corresponding compliance training. Training manager 220 may also create a record of the user's progress with the corresponding compliance training in user data storage 226. Risk manager 224 or system administrator 212 may decide whether there is harm in granting a user a new user status for platform 202-1 in relation to an event before the completion of the corresponding compliance training, or if the new user status should be applied after the completion of the corresponding compliance training. Risk manager 224 or system administrator 212 may determine the length of time that is appropriate for a user to complete corresponding compliance training. In step 618, event manager 222 may be configured to intercept or revoke event commands to platform 202-1 based on the user status and corresponding compliance training completion status.

In step 614, rules engine 218 may compare one or more rules that match the event to determine corresponding compliance training. In step 616, training manager 220 assigns and/or administers corresponding compliance training, tracks corresponding compliance training completion, and provides corresponding compliance training completion status. In step 618, based on a risk assessment by risk manager 224 or based on corresponding compliance training completion status determined by training manager 220, event manager 222 may intercept or revoke commands to platform 202-1.

In examples, in addition to providing corresponding compliance training to a user in response to an event, rules engine 218 may determine other actions to take for the user such as adding the user to certain communication channels (e.g., slack channels, Teams channels), email distribution groups, calendar managers, meetings, or any other action. In some examples, event record manager 216 may send an alert to security awareness system 210 and provide the event record, such that security awareness system 210 and/or system administrator 212 may determine whether to provide security awareness training to the user. An audit trail or record of the compliance training that is allocated to and completed by each user is automatically created by training manager 220.

To elaborate the operations described above, consider an example event where a user is promoted on a team of software engineers, and is given developer permissions in a platform GitHub 202-1 by platform administrator 232-1. The user currently has viewer permissions and can view the source code but developer permissions mean that the user may view, download, and edit the source code. In an example, event record manager 216 may receive notification of the event and prompt the adapter 204-1 to identify event information. In an example, an event (for example a change of user status with a user receiving developer permissions on platform, GitHub 202-1) is detected and processed by GitHub adapter 204-1. GitHub adapter 204-1 may retrieve (or pull) event information relating to the user's permission (user status) change, and may populate an event record shown in Table 1.

TABLE 1

| | |
|---|---|
| User ID: | 123 456 789 |
| Platform: | GitHub |
| Old permission: | viewer |
| New permission: | developer |

GitHub adapter 204-1 may use API 206-1 to extract the name of the user, the time of the event, old permission level of the user, a new permission level of the user, and any other data to populate an event record. The event record is received/recorded by event record manager 216 in event record storage 234. Continuing the example, event record manager 216 processes the event record and determines the following example provided in Table 1. Event record manager 216 may process data, such as platform identity, organization's identity, user's identity, event description and changes in user's status from the event record created by GitHub adapter 204-1. Based on processing, event record manager 216 may identify and record a change in the user's permissions from viewer to developer. Risk manager 224 may determine that there is a risk in allowing the user to have the new status without the user completing compliance training, and thus prompts rules engine 218 for determining appropriate applicable rules for compliance training. Rules engine 218 may determine and apply one or more rules that has been defined for change in GitHub permissions from a viewer to a developer role. Rules engine 218 applies a rule that aligns with the data in the identified fields in the event record and rules engine 218 identifies “Git Hub Developer Compliance training” is required. Training manager 220 assigns the compliance training and tracks the user's progress as they complete the compliance training. Based on the applied rules, training manager 220 may provide the appropriate user compliance training to the user for developer status. Upon completion of compliance training by the user within a defined time frame, training manager 220 may create a record of the user's completion of the compliance training. Event record manager 216 may apply the user status change within GitHub 202-1 or may causer or trigger the GitHub platform 202.1 to apply the user status change, or may prompt an administrator 212 to apply the user status change to GitHub platform 202-1. An audit trail of the compliance training that is allocated to and completed by each user is automatically created by training manager 220.

In another example, in a platform Lucidchart 202-2, an event may occur that changes status that includes permissions of a user to share documents over previous document viewing only permissions. A rule may have been defined by rules engine 218 that identifies any elevation in privilege that includes document sharing permissions in the platform Lucidchart 202-2. In an example, the rule may be matched to the event record and the rule may specify that the corresponding user compliance training is training pertaining to document sharing practices. When an event record with matching conditions is processed by that rule, training manager 220 assigns the user corresponding compliance training according to the rule. Upon completion of corresponding compliance training within a defined time frame or period, event record manager 216 may apply the user status change within Lucidchart 202-2.

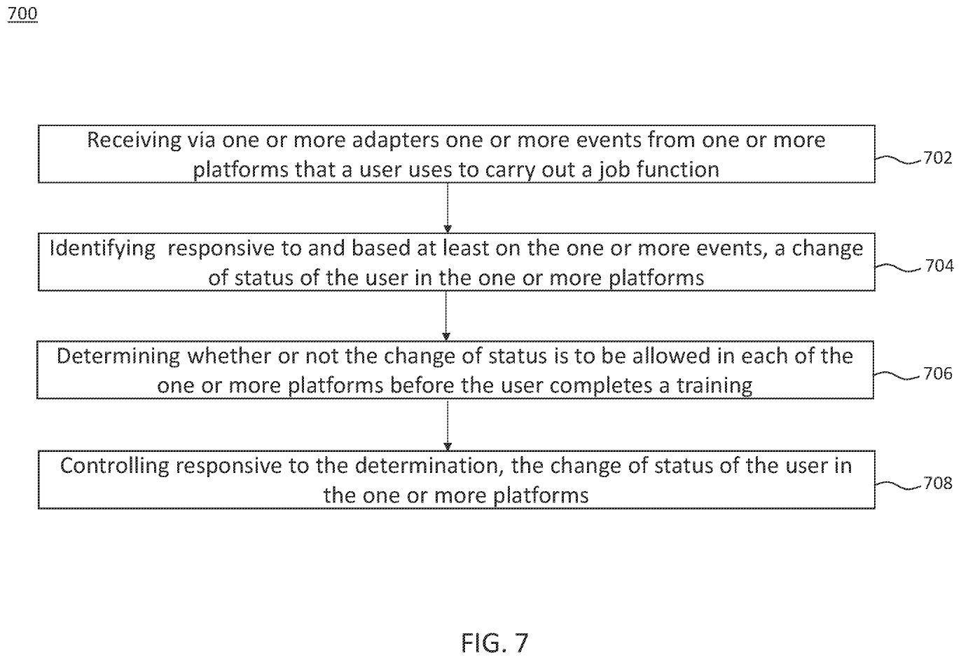

FIG. 7 depicts an example flowchart for management of compliance training, according to some embodiments. In a brief overview of an implementation of flowchart 700, at step 702, one or more events triggered from one or more platforms 202-(1-N) that a user uses to carry out a job function may be received via one or more adapters 204 (1-N). At step 704, responsive to and based at least on the one or more events, a change of status of the user in the one or more platforms 202-(1-N) may be identified. At step 706, whether or not the change of status is to be allowed before the user completes a training may be determined in each of the one or more platforms 202-(1-N). At step 708, responsive to the determination, the change of status of the user in the one or more platforms 202-(1-N) may be controlled.

Step 702 includes receiving, via one or more adapters 204 (1-N), one or more events from one or more platforms 202-(1-N) that a user uses to carry out a job function. In one example, event record manager 216 may receive notifications of one or more events and may prompt adapter 204 (1-N) to obtain the information associated with the one or more events from the one or more platforms 202-(1-N). In another example, one or more adapters 204 (1-N) may obtain the information associated with the one or more events from one or more platforms 202-(1-N) when one or more platforms 202-(1-N) notifies adapter 204 (1-N) of the one or more events. One or more adapters 204 (1-N) may generate an event record using the information associated with the one or more events from platforms 202-(1-N).

Step 704 includes identifying, responsive to and based at least on the one or more events, a change of status of the user in the one or more platforms 202-(1-N). In one example, event record manager 216 may process the event record to determine the change of status of the user in the one or more platforms 202-(1-N). Based on the one or more events, rules engine 218 may apply one or more rules to the one or more events to determine the training that is to be completed by the user before the change of the status is implemented in the one or more platforms 202-(1-N). In some examples, risk manager 224 determines a level of harm if the user is allowed the change in status in the one or more platforms 202-(1-N) before the user completes the training. Step 706 includes determining whether or not the change of status is to be allowed in each of the one or more platforms 202-(1-N) before the user completes a training. In some examples, risk manager 224 may determine whether the change of status is to be allowed while the user completes the training. In some examples, event record manager 216 may determine whether the change of status of the user is to be withheld while the user completes the training. In some examples, system administrator 212 may determine whether the change of status of the user is to be withheld while the user completes the training.

In some examples, event record manager 216 may identify that the user is designated as a candidate for one or more types of the one or more events and may assign the user training to complete to implement the change in status in the one or more platforms 202-(1-N). In some examples, event record manager 216 may cause the change in status in the one or more platforms 202-(1-N) responsive to the user completing the training. In some examples, event record manager 216 may cause the change in status in the one or more platforms 202-(1-N), and training manager 220 tracks progress or completion of the training of the user. In some examples, event record manager 216 may disable the change in status in the one or more platforms 202-(1-N) responsive to the user not completing the training within a set period.

Step 708 includes controlling, responsive to the determination, the change of status of the user in the one or more platforms 202-(1-N). In some examples, risk manager 224 may control the change of status of the user. In some examples, the change of status in the one or more platforms 202-(1-N) may be controlled by accessing the one or more platforms 202-(1-N) via one or more APIs 206-(1-N).

As a result of the automated compliance management due to ACT system 208, the user is assigned appropriate compliance training only when required. An example scenario may include a user working in finance who gains access to regulated sensitive financial information where the event is the increase in access to the platform where the regulated sensitive financial information is stored. Another example may be a user who begins working in a medical office who may have to comply with Health Insurance Portability and Accountability Act (HIPAA) regulations regarding sensitive medical information, where the event is the addition of the user as an employee in the HR system of the medical offices and the platform is Dayforce. Another example may include a user gaining access to confidential projects within an organization where the event may be a change of user permissions which enables the user to access the confidential projects, and the platform is GitHub. Each example scenario may require different compliance training to be assigned to a user.

The systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

We claim:

1. A method comprising
receiving, by one or more servers, via one or more adapters one or more events triggered from one or more platforms that a user uses to carry out a job function;
identifying, by the one or more servers responsive to and based at least on the one or more events, a change of status of the user in the one or more platforms;
determining, by the one or more servers, whether or not the change of status is to be allowed in each of the one or more platforms before the user completes a training; and
controlling, by the one or more servers responsive to the determination, the change of status of the user in the one or more platforms.

2. The method of claim 1, further comprising applying, by the one or more servers, one or more rules to the one or more events to determine the training that is to be completed by the user before the change of the status is implemented in the one or more platforms.

3. The method of claim 1, further comprising determining, by the one or more servers, a level of harm if the user is allowed the change in status in the one or more platforms before the user completes the training.

4. The method of claim 1, further comprising determining, by the one or more servers, the change of status is to be allowed while the user completes the training.

5. The method of claim 1, further comprising determining, by the one or more servers, the change of status of the user is to be withheld while the user completes the training.

6. The method of claim 5, further comprising identifying, by the one or more servers, that the user is designated as a candidate for one or more types of the one or more events and assigning the user training to complete to implement the change in status in the one or more platforms.

7. The method of claim 6, further comprising causing, by the one or more servers, the change in status in the one or more platforms responsive to the user completing the training.

8. The method of claim 6, further comprising causing, by the one or more servers, the change in status in the one or more platforms and tracking progress or completion of the training of the user.

9. The method of claim 6, further comprising disabling, by the one or more servers, the change in status in the one or more platforms responsive to the user not completing the training within a set period.

10. The method of claim 1, further comprising controlling, by the one or more servers, the change of status in the one or more platforms by accessing the one or more platform via one or more application programming interfaces (APIs).

11. A system comprising one or more servers to:
receive via one or more adapters one or more events triggered from one or more platforms that a user uses to carry out a job function;
identify, responsive to and based at least on the one or more events, a change of status of the user in the one or more platforms;
determine whether or not the change of status is to be allowed in each of the one or more platforms before the user completes a training; and
control, responsive to the determination, the change of status of the user in the one or more platforms.

12. The system of claim 11, wherein the one or more servers are further configured to apply one or more rules to the one or more events to determine the training that is to be completed by the user before the change of the status is implemented in the one or more platforms.

13. The system of claim 11, wherein the one or more servers are further configured to determine a level of harm if the user is allowed the change in status in the one or more platforms before the user completes the training.

14. The system of claim 11, wherein the one or more servers are further configured to determine the change of status is to be allowed while the user completes the training.

15. The system of claim 11, wherein the one or more servers are further configured to determine the change of status of the user is to be withheld while the user completes the training.

16. The system of claim 15, wherein the one or more servers are further configured to identify that the user is designated as a candidate for one or more types of the one or more events and assigning the user training to complete to implement the change in status in the one or more platforms.

17. The system of claim 16, wherein the one or more servers are further configured to cause the change in status in the one or more platforms responsive to the user completing the training.

18. The system of claim 16, wherein the one or more servers are further configured to cause the change in status in the one or more platforms and tracking progress or completion of the training of the user.

19. The system of claim 16, wherein the one or more servers are further configured to disable the change in status in the one or more platforms responsive to the user not completing the training within a set period.

20. The system of claim 11, wherein the one or more servers are further configured to control the change of status in the one or more platforms by accessing the one or more platform via one or more application programming interfaces (APIs).
